(19) United States
(12) Patent Application Publication
(10) Pub. No.: US 2009/0019986 A1
(43) Pub. Date: Jan. 22, 2009

(54) Drumstick with Integrated microphone

(76) Inventor: William T. Simpkins, III, Washington, DC (US)

Correspondence Address: QUICKPATENTS, INC., 32861 CALLE PERFECTO, SUITE A, SAN JUAN CAPISTRANO, CA, 92675, US

(21) Appl. No.: 11/780,434

(22) Filed: Jul. 19, 2007

(51) Int. Cl. G10D 13/02

(52) U.S. Cl. 84/422.4

(57) ABSTRACT

A combination drumstick and microphone for striking a surface, such as a drum surface or other percussion instrument or device, is disclosed. The drumstick has a channel or conduit formed therein that has a longitudinal axis generally parallel with the longitudinal axis of the drumstick, and that preferably extends from proximate a striking end of the drumstick to proximate a rear end of the drumstick. The microphone is preferably selectively fixed within the channel or conduit, and includes a signal conveying means such as a electrical signal cable or a wireless transmitter. The channel or conduit includes an enlarged portion adapted to selectively hold the microphone and a narrow portion adapted to selectively hold at least a portion of the signal cable, antenna wire, or the like. In one embodiment of the invention, the microphone protrudes at least partially from the striking end so as to strike the drum surface directly. A method of use of a simple embodiment of the invention is also disclosed.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE INVENTION

This invention relates to musical instruments, and more particularly to a novel striking instrument taking the form of, in one embodiment, a combination drumstick and microphone.

### DISCUSSION OF RELATED ART

Drum and percussion sets, when used in a music performance, are typically wired with a plurality of microphones, each of which requires its own audio channel into an audio mixing board. As such, drum and percussion sets are often time consuming to set-up, to mix within the mixing board, and to keep balanced during the music performance. Moreover, when such a drum or percussion set is fully wired with microphones, the plurality of audio cables emanating from the set can be difficult to manage and present multiple tripping hazards for those performing on stage. Should one cable inadvertently become unplugged, it can be time consuming to find the corresponding microphone and disastrous to the performance.

Several prior-art patents teach hollow drumsticks. For example, U.S. Pat. No. 4,763,557 to Donohoe on Aug. 16, 1988; U.S. Pat. No. 4,385,544 to Heiskell on May 31, 1983; and U.S. Pat. No. 4,320,688 to Donohoe on Mar. 23, 1983, are all examples of substantially hollow drumsticks. None of these devices, however, teach placing a microphone within the hollow portions thereof. Other prior art patents, such as U.S. Pat. No. 6,479,737 to Lebeda on Nov. 12, 2002; and U.S. Pat. No. 4,106,079 to Drury on Aug. 8, 1978, teach drumsticks with light-emitting means contained therein. While such devices may include electronic components within a hollow body of a drumstick, none of these devices teach or even suggest the placement of a microphone therein.

Another prior art device, sold under the name “Mijam Drummer,” produced by Blue-Box Toys of Hong Kong, with sales offices in Livingston, N.J., USA, is a pair of drumsticks having motion sensors and signal processing electronics therein. Such a product simulates drums or other instruments, but does not provide microphone means embedded within the drumsticks themselves.

Other drumstick type devices are known, such as US 2006/0243118 to Malott on Nov. 2, 2006, which includes a hollow body capable of receiving a retractable tip for producing variable sounds with a single drumstick. U.S. Pat. No. 6,423,890 to Zbrzezny et al. on Jul. 23, 2002, teaches a drumstick with a variable auxiliary grip.

US Patent Application 2006/0021495 to Freitas on Feb. 2, 2006 teaches an electric percussion instrument that utilizes “close micing,” wherein electronic sensors or “triggers” sense vibrations and produce corresponding electrical signals. Such an system, however, does not contemplate utilizing such an electronic sensor in the tip of a drumstick or as a striking implement itself. With such a system, electronic sensors are fixed to each drum or other struck surface, and thus a large number of such electronic sensors are required. U.S. Pat. No. 6,982,376 to Wise on Jan. 3, 2006 has similar drawbacks. Further, the closer a microphone or trigger is to the surface being struck the less time delay there is between the surface being struck and the sound entering the microphone or trigger to be processed. If the microphone or trigger itself were the implement that strikes the surface, this time would be minimized.

U.S. Pat. No. 4,860,364 to Giannini on Aug. 22, 1989 teaches a sound generating coat that has a plurality of sensors or triggers in pockets for striking to produce noise. With such a system, each pocket includes a sensor or trigger, and thus a large number of such electronic sensors are required.

Consequently, for practicing, recording, or performing music, there is a need for a system of reducing the necessary number of wired microphones in a typical drum or percussion set. Such a needed device would provide microphone placement in close proximity to any surface being struck, and would preferably allow for alternate types of sounds to be produced over what is typical in such drum or percussion sets. Further, such a needed device would be easy to swap-out with another such device if the first device malfunctions or otherwise fails. Still further, such a needed device would render midi-type or practice pads obsolete, as any surface could be used as a drum surface. Such a device would be useful as a midi-type trigger device, and could use the microphone or trigger as the striking implement itself The present invention accomplishes these objectives.

### SUMMARY OF THE INVENTION

The present device is, in one preferred embodiment, a combination of a drumstick and microphone for striking a surface, such as a drum surface, other percussion instrument, or any other convenient surface including one's own body. The drumstick has a channel or conduit formed therein that has a longitudinal axis generally parallel with the longitudinal axis of the drumstick, and that preferably extends from proximate a striking end of the drumstick to proximate a rear end of the drumstick. In the simplest embodiment of the invention, the housing of a microphone, transducer, sensor, trigger, or the like includes a housing that is used as the striking implement itself. It is understood that herein the term “microphone” may include any type of electrical signal producing device sensitive to vibration, such as acoustic transducers, sensors, electronic triggers, piezoelectric crystals, and the like.

The microphone is preferably selectively fixed within the channel or pocket, and includes a signal conveying means such as a electrical signal cable or a wireless transmitter. In the embodiment having the signal cable, the channel or conduit includes an enlarged portion adapted to selectively hold the microphone and a narrow portion adapted to selectively hold at least a portion of the signal cable, antenna wire, or the like.

The present invention is a system of reducing the necessary number of wired microphones in a typical drum or percussion set by embedding in or otherwise combining a microphone with each of a drummer's drumsticks. The present device provides microphone placement in close proximity to any surface being struck, thereby obviating the practice of “close micing,” and allows for alternate types of dragging or scratching sounds to be produced. Further, if a drumstick of the present invention fails, such as by breaking, the drummer can easily grab an alternate such drumstick that has been previously set-up in the sound mixing board and continue playing. Still further, the present device renders current midi-type recording triggers, performance drums, and practice pads obsolete, as any surface can be used as a drum surface. The microphones of the present device may be plugged into a personal amplifier, laptop computer, or the like to allow a person to practice or record drumming on any convenient suitable surface, even surfaces that are relatively noise-free when impacted. Midi-type applications may be easily triggered by the present invention when combined with the proper signal processing means, such as a midi-input device. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a perspective view of the invention, illustrating the invention in use;

FIG. 2 is a bottom plan view of the invention, illustrating a preferred embodiment of the invention;

FIG. 3 is a bottom plan view of the invention, illustrating an alternate embodiment of the invention;

FIG. 4 is a cross-sectional view of the invention, taken generally along lines 4-4 of FIG. 2;

FIG. 5 is a top plan view of the preferred embodiment of the invention;

FIG. 6 is a cross-sectional view of the invention, taken generally along lines 6-6 of FIG. 5;

FIG. 7 is a top plan view of another alternate embodiment of the invention;

FIG. 8 is a cross-sectional view of the invention, taken generally along lines 8-8 of FIG. 7;

FIG. 9 is a side elevational view of a simplified embodiment of the invention; and

FIG. 10 is a close-up side elevational view of a microphone of the present invention.

### DETAILED DESCRIPTION OF THE PREFERRED EMBODIMENT

FIGS. 1-3 illustrate a combination 10 of a drumstick 20 and microphone 40 for striking a surface 15, such as a drum surface or other musical or percussion instrument or device, or any other type of surface, including one's own body (not shown).

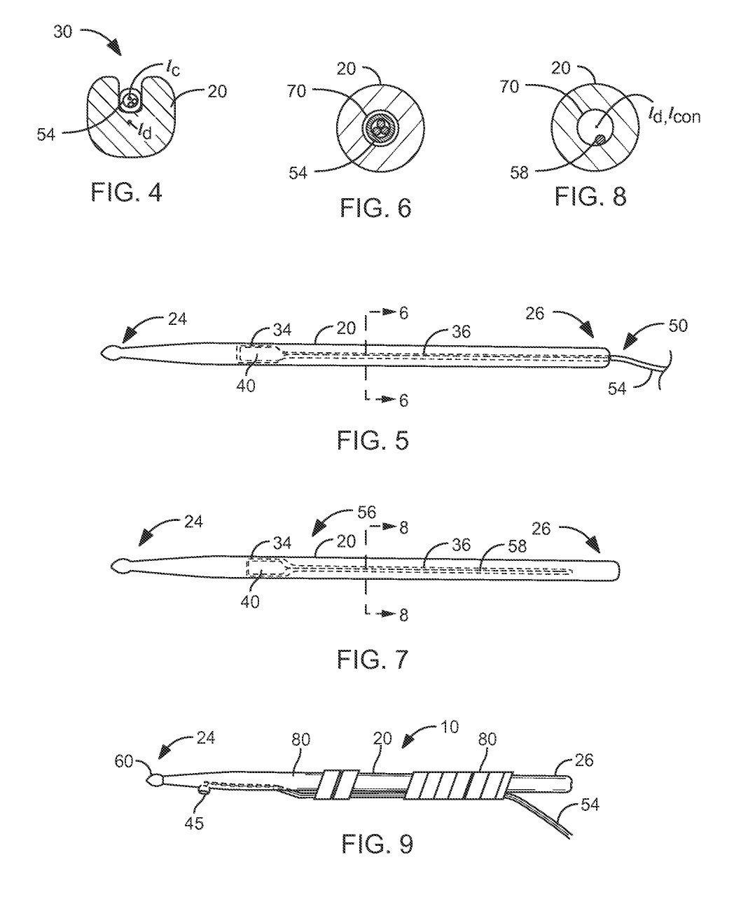

The drumstick 20, typically made from wood or a substantially rigid material, has a channel 30 formed therein, a rear end 26, and a striking end 24. The channel 30 has a longitudinal axis l_{c} generally parallel with the longitudinal axis l_{d} of the drumstick 20 (FIG. 4), and preferably extends from proximate the striking end 24 of the drumstick 20 to proximate the rear end 26 of the drumstick 20. The drumstick 20 is preferably of the type having a generally rounded striking tip 60 at the striking end 24. However, in one embodiment of the invention, illustrated in FIG. 3, the microphone 40 at least partially projects out from the striking end 24 of the drumstick 20 so that, during use, the microphone 40 itself may strike the surface 15.

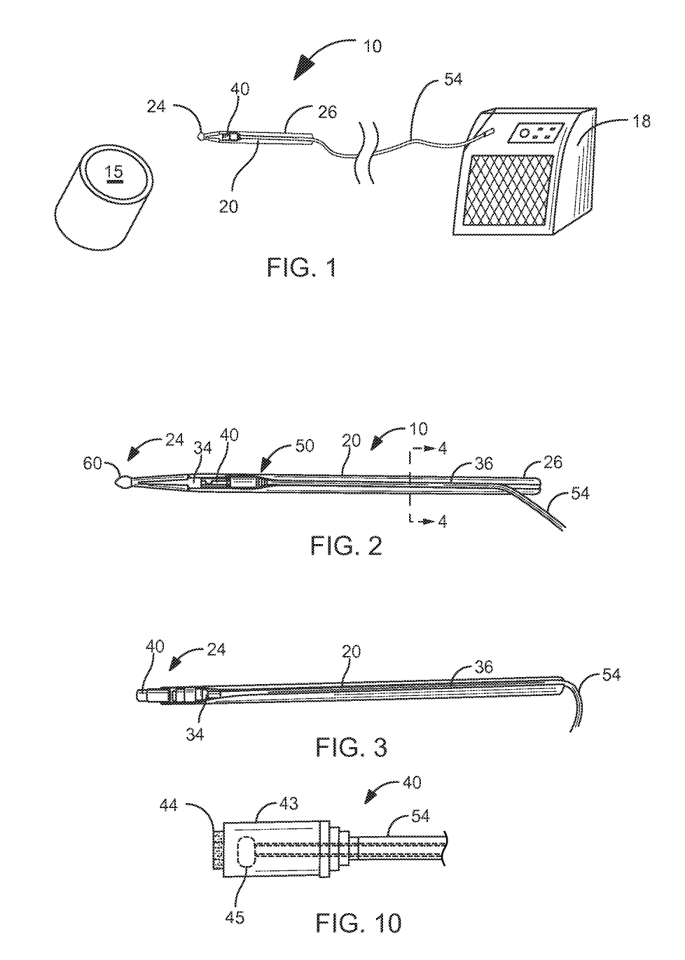

The microphone 40 is preferably selectively fixed within the channel 30, and includes a signal conveying means 50 such as a electrical signal cable 54 (FIGS. 2, 3, and 5) or a wireless transmitter 56 (FIG. 7). In the embodiment having the signal cable 54, the channel 30 includes an enlarged portion 34 adapted to selectively hold the microphone 40 and a narrow portion 36 adapted to selectively hold at least a portion of the signal cable 54 (FIGS. 2, 5, and 7). Electrical tape (FIG. 9), glue, or the like, may be used around the drumstick 20 to keep the microphone 40 and signal cable 54 retained therein, if necessary.

In one embodiment of the invention, illustrated in FIG. 5, the drumstick 20 has a conduit 70 formed therein as opposed to the channel 30. The conduit 70 preferably has a longitudinal axis l_{con} coincident with the longitudinal axis l_{d} of the drumstick 20 (FIG. 8). As such, the microphone 40 is fixed within the drumstick 20, as is the signal conveying means 50. Preferably with this embodiment the conduit 70 is open proximate the rear end 26 of the drumstick 20 so that the signal cable 54 may exit the conduit 70. In one embodiment of the invention, the drumstick 20 may include the channel 30 in a portion of the drumstick 20, and the conduit 70 in a remaining portion of the drumstick 20 (not shown). For example, the rear end 26 of the drumstick 20 may include the conduit 70, giving such an embodiment (not shown) the feel of a traditional drumstick 20.

Alternately, when the signal conveying means 50 is a wireless transmitter 56, the conduit 70 may be closed, the wireless transmitter 56 and any antenna wire 58 thereof thus being completely contained within the drumstick 20 (FIG. 7). The drumstick 20, in such an embodiment, may be selectively opened, with a two-part screw thread in a similar manner as a ballpoint pen (not shown), so that the wireless transmitter 56 may be removed, such as to replace batteries thereof (not shown), for example, or to replace the microphone 40 with an alternate microphone 40. In such an embodiment, the drumstick 20 may be made from any suitably rigid yet light-weight wood, plastic, carbon, or metal, such as aluminum, or a rigid plastic carbon fiber material, for instance. Alternately, the drumstick 20 may be integrally formed with the microphone 40 components therein (not shown), such that the microphone 40 may not be removed from the drumstick 20.

In the simplest embodiment of the invention, illustrated in FIG. 9, the microphone 40 is fixed to or within the drumstick 20 with an attachment means 80, such as electrical tape, adhesive, mechanical fastener, or the like. While not a preferred embodiment because the signal cable 54 is not contained within the drumstick 20, such an embodiment does fall under the spirit and scope of the present invention.

In a sense, in such an embodiment, as shown in FIG. 9, the microphone 40 is turned upside down and may be considered the actual musical instrument itself. As such, one method of performing with such an embodiment is to hold the microphone 40 itself, apart from the drumstick 20, wherein an enclosure 43 (FIG. 10) of the microphone 40 takes the place of the substantially hollow drumstick 20, and a microphone element 45 or pickup within the microphone 40 transfers sounds made by striking a head 44 or the enclosure 43 against the surface 15. In use, the performer may grasp such a microphone 40 and either tap on it with his fingers (not shown), or impact the head 44 or enclosure 43 against various surfaces 15 to produce various acoustic impact sounds, or scratch or drag the head 44 or enclosure 43 across various surfaces 15 to produce scratching or distortion sounds unique in the music industry.

In use, the combination 10 may be used to strike drum surfaces 15, or other objects to create various types of percussion sounds through the microphone 40. The striking end 24 of the combination 10 may also be dragged across various surfaces to create a “scratching” or distortion sound, adding a dimension to percussion instruments heretofore not achievable. The combination 10 has the effect of rendering any surface 15 suitable for use in drumming practice, performance, or recording, and renders midi-type drum pads and the like obsolete since the microphone 40 or other midi-type audio pickup (not shown) does not necessarily have to be associated with the surface 15 being struck by the drumstick 20.

The signal conveying means 50 conveys sounds signals produced by the microphone 40 to a signal processing device 18, such as an amplifier, laptop computer, iPod, effects device, headphones, or the like. Certain of the signal processing functions may be included within the drumstick 20, such as amplification of the sound signals or the like, by further including a circuit board with associated circuitry therein (not shown).

While a particular form of the invention has been illustrated and described, it will be apparent that various modifications can be made without departing from the spirit and scope of the invention. For example, the microphone 40 may be placed anywhere along the longitudinal axis l_{d} of the drumstick 20. Further, various types of microphones 40 may be used. It is to be understood that herein the term microphone 40 may refer to a microphone element, audio transducer, or any device suitable for sensing acoustic energy. The microphone 40 may be placed at an oblique angle with respect to the longitudinal axis of the drumstick 20. Still further, various types of signal conveying means 50 may be used, from wired to wireless, including wireless signal conveying means that utilize radio waves, infrared, ultrasonic, or amplified audio sounds, for example. Accordingly, it is not intended that the invention be limited, except as by the appended claims.

What is claimed is:

1. A combination drumstick and microphone for striking a surface, comprising:
an elongated drumstick having a channel formed therein, a rear end, and a striking end, the channel having a longitudinal axis generally parallel with the longitudinal axis of the drumstick; and
a microphone selectively fixed within the channel, the microphone including signal conveying means;
whereby when the striking end of the drumstick strikes the surface, the microphone conveys sound signals to a signal processing device by the signal conveying means.

2. The combination of claim 1 wherein the striking end of the drumstick includes a generally rounded striking tip.

3. The combination of claim 1 wherein the microphone at least partially projects out from the striking end of the drumstick, and wherein the microphone is adapted to strike the surface directly.

4. The combination of claim 1 wherein the signal conveying means is a signal cable fixed to the microphone, and wherein the channel includes an enlarged portion adapted to selectively hold the microphone and a narrow portion adapted to selectively hold at least a portion of the signal cable.

5. The combination of claim 1 wherein the signal conveying means is a wireless transmitter.

6. The combination of claim 1 wherein the channel extends from proximate the striking end of the drumstick to proximate the rear end of the drumstick.

7. A combination drumstick and microphone for striking a surface, comprising:
an elongated drumstick having a conduit formed therein, a rear end, and a striking end, the conduit having a longitudinal axis generally parallel with the longitudinal axis of the drumstick; and
a microphone fixed within the drumstick, the microphone including signal conveying means;
whereby when the striking end of the drumstick strikes the surface, the microphone conveys sound signals to a signal processing device by the signal conveying means.

8. The combination of claim 7 wherein the striking end of the drumstick includes a generally rounded striking tip.

9. The combination of claim 7 wherein the microphone at least partially projects out from the striking end of the drumstick, and wherein the microphone is adapted to strike the surface directly.

10. The combination of claim 7 wherein the signal conveying means is a signal cable fixed to the microphone, and wherein the conduit includes an enlarged portion adapted to hold the microphone and a narrow portion adapted to hold at least a portion of the signal cable.

11. The combination of claim 7 wherein the signal conveying means is a wireless transmitter.

12. The combination of claim 7 wherein the conduit extends from proximate the striking end of the drumstick to proximate the rear end of the drumstick.

13. The combination of claim 11 wherein the wireless transmitter includes an antenna wire fixed to the microphone and at least partially captured within the conduit.

14. A method of creating musical sounds, comprising the steps of:
a) obtaining a microphone that includes a microphone element, a microphone enclosure, and a signal conveying means;
b) grasping the microphone in one hand;
c) striking or dragging the microphone against a surface to produce sound, the microphone element conveying the sound to a signal processing means through the signal conveying means.

15. A method of creating musical sounds, comprising the steps of:
a) obtaining a pair of microphones that each include a microphone element, a microphone enclosure, and a signal conveying means;
b) grasping one of the microphones in each hand;
c) striking or dragging the microphones against various surfaces to produce various types of sounds, the microphone elements in each microphone conveying the sound to a signal processing means through the signal conveying means.
